(19) United States
(12) Patent Application Publication
(10) Pub. No.: US 2024/0222055 A1
(43) Pub. Date: Jul. 4, 2024

(54) BUSHING COMPRISING A CONNECTION TERMINAL, AND HOUSING AND RELAY COMPRISING SUCH A BUSHING

(71) Applicant: SCHOTT AG, Mainz (DE)

(72) Inventor: Helmut HARTL, Klosterneuburg (AT)

(73) Assignee: SCHOTT AG, Mainz (DE)

(21) Appl. No.: 18/610,735

(22) Filed: Mar. 20, 2024

Related U.S. Application Data
(63) Continuation of application No. PCT/EP2022/077903, filed on Oct. 7, 2022.

(30) Foreign Application Priority Data
Oct. 14, 2021 (DE) 10 2021 126 633.5

(51) Int. Cl. H01H 50/02; H01H 50/14

(52) U.S. Cl. CPC H01H 50/023; H01H 50/14

(57) ABSTRACT

A bushing with a connection terminal for a high-power relay is disclosed The connection terminal arrangement includes a connection terminal made of a first material and a pipe lead made of a second material. The connection terminal arrangement further includes a flexible element via which the pipe lead is connected to the connection terminal. The flexible element encloses a pin portion of the connection terminal and there being a second gap between the pin portion of the connection terminal and the flexible element. The flexible element is formed integrally with the pipe lead as a portion of the pipe lead having a reduced thickness, or the flexible element is made from a third material, or the flexible element is formed integrally with the connection terminal. A housing and a relay which each include one such bushing are also disclosed.

### CROSS-REFERENCE TO RELATED APPLICATIONS

This application is a continuation of PCT International Application No. PCT/EP2022/077903, filed Oct. 7, 2022, which claims the benefit of German Patent application No. 10 2021 126 633.5, filed Oct. 14, 2021, the contents of each of which are incorporated herein by reference.

### FIELD OF THE INVENTION

The invention relates to a bushing with a connection terminal, in particular for a high-power relay, comprising a housing part with a through-opening and a connection terminal arrangement, which is fed through the through-opening and is sealed from the through-opening by a fixing material. Further aspects of the invention relate to a housing and to a relay, which respectively comprise at least one such bushing.

### BACKGROUND OF THE INVENTION

The prior art discloses relays with which electric currents can be switched on and off. One example involves high-power relays which are used in electric vehicles or hybrid vehicles in order to disconnect a traction battery, which provides the electrical energy for the vehicle, reliably from an electrical system of the vehicle. Such a relay comprises a housing, electrical bushings for the circuit to be switched and a contacting device, which connects or disconnects two terminals in order to switch the current. The contacting device may be actuated with an actuator, for example in the form of an electromagnet. The interior of the housing is usually sealed in order on the one hand to prevent ingress of moisture and on the other hand to keep an extinguishing gas, which may be provided in the housing in order to extinguish an arc, inside the housing.

EP3358593 B1 discloses a hermetic connection which is suitable in particular for a high-power relay. The hermetic connection comprises a metal container with a through-hole, a pipe lead which is fed through the through-hole, an insulating glass which hermetically seals the pipe lead and the metal container, and a connection base which extends through the pipe lead and is hermetically connected thereto. The connection base is made from a material with a low resistance and is arranged in the connection in such a way that there is a gap between an inner circumferential face of a portion of the pipe lead which is in contact with the insulating glass and an outer circumferential face of a corresponding portion of the connection base. In the event of thermal expansion of the connection base, the pipe lead deforms so that damage to the insulating glass is avoided.

In the known bushings, the flexibility needed in order to compensate for thermal expansion of the connection terminal is provided by the pipe lead, which for this purpose must have a minimum length or minimum height. The known bushings therefore have a comparatively large overall height. In order to be able to make housings with such bushings more compact overall, it is an object of the invention to provide a bushing having a connection terminal that has a small overall height.

The known bushings need to be resilient in order to be able to absorb length changes due to thermal expansion of a connection terminal. If a compression glass-to-metal seal is desired for hermetic sealing, the counterpressure required therefor cannot however be applied by the known pipe leads. Accordingly, one object of the invention may be regarded as providing a bushing which is suitable for a compression glass-to-metal seal.

When using screw connections between a connection terminal and a lead, tightening of the connecting screws may cause high torques which cannot be optimally absorbed by the known hermetically sealed connection terminals. Accordingly, a further object of the invention may be regarded as providing a bushing having a connection terminal, with which bushing the absorption and transmission of torques introduced on the connection terminal are improved.

### SUMMARY OF THE INVENTION

A bushing with a connection terminal is proposed, which is suitable in particular for a high-power relay. The bushing comprises a housing part with a through-opening and a connection terminal arrangement, which is fed through the through-opening and is sealed from the through-opening by a fixing material. The connection terminal arrangement comprises a connection terminal made of a first material and a pipe lead made of a second material, the pipe lead enclosing at least a part of the connection terminal and the fixing material being arranged between an outer wall of a sleeve portion of the pipe lead and an inner wall of the through-opening in order to seal the connection terminal arrangement, there being a first gap between an inner wall of the sleeve portion and the connection terminal. The fixing material mechanically fixes the connection terminal arrangement in the through-opening and electrically insulates it from the housing part. Further, the connection terminal arrangement comprises a flexible element via which the pipe lead is connected to the connection terminal, the flexible element enclosing a pin portion of the connection terminal and there being a second gap between the pin portion of the connection terminal and the flexible element. The flexible element is in a first variant i) formed integrally with the pipe lead as a portion of the pipe lead having a reduced thickness. In a second variant ii), the flexible element is made from a third material. In a third variant iii), the flexible element is formed integrally with the connection terminal.

The connection terminal has a pin portion, which is used particularly as an electrical conductor in the bushing. The pin portion is preferably configured substantially cylindrically, particularly in the form of a circular cylinder, although other shapes may also be envisioned. For example, cylindrical shapes with an oval, rectangular or square cross section may also be envisioned. Furthermore, it would be conceivable for the pin portion to be shaped fully or partially conically. The pipe lead with the sleeve portion, and the flexible element, enclose the pin portion at least partially. Preferably, their cross-sectional shape is selected so as to correspond to the cross-sectional shape of the pin portion.

In the first variant of the invention, the resilience of that part of the pipe lead which is used as a flexible element is increased by reducing the thickness. This reduction of the thickness takes place particularly in relation to the sleeve portion so that a thickness, in particular a wall thickness, of the pipe lead in the region of the flexible element is less than the thickness in the region of the sleeve portion.

In the second variant of the invention, the resilience of the flexible element is increased by making it from a different material. The third material is preferably selected in such a way that its modulus of elasticity is less than that of the second material of the pipe lead. In this way, the resilience is increased even if the flexible element has the same wall thickness as the pipe lead in the sleeve region. In addition, however, a thickness or wall thickness of the flexible element may of course be selected to be less than the thickness of the pipe lead in the sleeve region, in order to increase the resilience even further.

In the third variant, the flexible element is formed integrally with the connection terminal and is therefore made from the same material as the connection terminal. The first material of the connection terminal usually has a lower modulus of elasticity than the second material of the pipe lead. A thickness, or a wall thickness, of the flexible element may also be selected independently of the thickness of the sleeve portion of the pipe lead so that a flexible element with good resilient properties is obtained. In particular, the thickness, or a wall thickness, of the flexible element may in this case be selected to be less than a thickness of the pipe lead in the sleeve portion.

All three variants allow the flexibility of the flexible element to be adjusted in relation to the bushings known from the prior art, irrespective of the properties of the sleeve region of the pipe lead, and make it possible to reduce the length of the flexible element so that the overall height of the bushing is reduced. An overall height in this case means in particular the length by which the connection terminal arrangement protrudes from the housing part.

The flexible element is preferably connected to the connection terminal or the pipe lead by means of welding or soldering.

This connection is preferably configured to be hermetically leaktight. The sealing between the pipe lead and the inner wall of the through-opening by the fixing material is preferably likewise configured to be hermetically leaktight.

Hermetically leaktight means in particular that, with a pressure difference of 1 bar, the helium leakage rate is less than 1·10⁻⁸ mbar l/s⁻¹, preferably less than 1·10⁻⁹ mbar l/s⁻¹.

Preferably, the connection terminal has at least one collar. The collar is configured in particular as a region of the connection terminal inside which an outer diameter of the connection terminal is increased in relation to an outer diameter in the pin portion.

Such a collar may have a constant diameter. Nevertheless, the diameter may also change abruptly in one or more steps or continuously in the region of the collar.

The at least one collar is preferably arranged on the connection terminal, and dimensioned, in such a way that the collar is arranged outside the through-opening.

Preferably, the flexible element according to variant i) or ii) is connected to the collar on a side of the latter facing toward the through-opening. In the case of an integral embodiment of the flexible element with the connection terminal according to variant iii), it is preferred for that portion of the connection terminal which forms the flexible element to start on the side of the collar facing toward the through-opening.

The outer diameter of the collar and the outer diameter of the flexible element may be selected to be equal, so that the flexible element ends flush on the collar. As an alternative thereto, the outer diameter of the flexible element may be selected to be smaller.

As an alternative to arranging the flexible element on a face of the collar facing toward the through-opening, the flexible element according to variant i) or ii) is preferably connected to the collar on a lateral face of the latter.

The connection terminal may comprise connecting means on one or both end sides in order to facilitate the connection of an electrical lead. These connecting means are configured, for example, as a threaded bore which allows screw connection to an electrical terminal. Such a threaded bore is preferably arranged at least on an outwardly facing side of the bushing.

As an alternative thereto, however, the connecting means may also be configured for example in the form of a plane face which is suitable for a solder or weld connection. In this context, the surface may be coated and/or roughened so that such connections adhere better.

The pipe lead or the flexible element, if the latter is formed integrally with the pipe lead, may comprise a flange in order to simplify the connection to the connection terminal, in particular to the collar of the connection terminal. For this purpose, a wall of the pipe lead may be folded to form a flange, or an end face of the pipe lead may be enlarged by adapting the outer and/or inner diameter.

A diameter of a connection location may also be increased by providing such a flange, so that torques acting on the connection terminal can be transmitted better without damage to the connection location.

If the flexible element is not formed integrally with the pipe lead, it is preferable for the pipe lead to have a continuous or abrupt increase in diameter on a side facing toward the flexible element outside the through-opening and for the pipe lead to be connected to the flexible element in this region with an increased diameter. In this case as well, the resulting increased diameter may improve transmission of torques acting on the connection terminal so that no damage to the bushing takes place, in particular when connecting a connection cable to the connection terminal by screwing.

Preferably, the flexible element is arranged and configured in such a way that the second gap between the flexible element and the pin portion is larger than or the same size as the first gap between the sleeve portion and the pin portion. If the flexible element is formed by extending the pipe lead with a reduced wall thickness, for example, then, in order to reduce the thickness, the inner diameter is preferably increased and the outer diameter maintained.

In particular when the bushing is intended for an electrical connection to high voltages of in particular more than 100 V and particularly preferably more than 1000 V, an insulation path provided by the fixing material is preferably extended by the arrangement of further insulation material. In this way, in particular, it is possible to reduce the occurrence of leakage currents and/or electric arcs which could otherwise cross over the insulation path provided only by the fixing material in the event of the presence of contaminants and/or moisture.

Preferably, for this purpose the fixing material and an adjacent portion of the housing part are covered with an insulation material on an upper side and/or on a lower side of the bushing.

The insulation material may be configured as an insulation disk of electrically insulating material. As an alternative or in addition, the insulation material may be configured in the form of a coating, particularly with an encapsulation compound, of an electrically insulating material.

In an embodiment as an insulation disk, the insulation material may in particular be selected from a glass, a glass-ceramic, a ceramic or a plastic, plastics being preferred. The insulation material could also be selected to be the same as the fixing material.

Preferably, the bushing is configured as a compression glass-to-metal seal in which a thermal expansion coefficient of the housing part is higher than a thermal expansion coefficient of the fixing material. The fixing material, which in this case is preferably a glass, is then for example provided as a pellet of glass powder and inserted together with the connection terminal arrangement or at least together with the pipe lead into the through-opening of the housing part. The fixing material is obtained from the pellet by heating this arrangement and vitrifies to the walls of the through-opening and of the pipe lead. Upon cooling, the housing part then contracts more than the fixing material because of the selection of the expansion coefficients, so that pressure is exerted continuously on the fixing material by the housing part in the finished bushing. In particular, this achieves the effect that the sealing has a high quality and remains permanently leaktight, and in particular hermetically leaktight, even under difficult conditions such as frequent temperature changes and high mechanical demands. The pipe lead is in this case configured and embodied in such a way that the fixing material is supported from the inside in this compression glass-to-metal seal. For this purpose, the sleeve portion has a thickness which is selected, in combination with the material selection of the pipe lead, in such a way that the sleeve portion can apply a sufficient counterpressure.

For an embodiment as a compression glass-to-metal seal, the material of the housing part and the fixing material are preferably selected in such a way that a thermal expansion coefficient of the housing part α_{housing} is at least 20% higher than a thermal expansion coefficient of the fixing material α_{glass}. For example, α_{housing} is selected in the range of from 12·10⁻⁶ 1/K to 19·10⁻⁶ 1/K and α_{glass} is selected in the range of from 9·10⁻⁶ 1/K to 11·10⁻⁶ 1/K.

As an alternative to a compression glass-to-metal seal, the thermal expansion coefficients of the housing part, fixing material and pipe bushing may also be matched to one another in such a way that the thermal expansion coefficient of the fixing material differs from those of the housing part and/or pipe lead by less than 20%, preferably less than 10% and particularly preferably by less than 5%.

Preferably, the first material, which is used for the connection terminal, has a lower electrical resistance than the second material, which is used for the pipe lead. Since the connection terminal is used as an electrical conductor in the bushing, a material with the lowest possible electrical resistance is preferred. In particular, this achieves the effect that the bushing is not excessively heated even with heavy currents.

Particularly in variants of the bushing in which the flexible element is embodied integrally with the connection terminal, it is preferred for the first material to have a lower modulus of elasticity than the second material. In this way, resilient deformation of the flexible element may take place even with relatively large material thicknesses.

If the flexible element is made from a third material and is correspondingly present as a separate component part, the third material for the flexible element according to variant ii) preferably has a lower modulus of elasticity than the second material of the pipe lead. It is furthermore preferred for the third material also to have a lower modulus of elasticity than the first material of the connection terminal.

Preferably, the first material of the connection terminal is selected from a nonferrous metal such as copper or a nonferrous metal alloy such as a copper alloy, in particular brass, aluminum or an aluminum alloy.

Preferably, at least one inwardly facing end side of the connection terminal is coated with a contact material in order to reduce the contact resistance and/or to reduce sparking. Optionally, however, both end sides may also be provided with such a contact material. The contact materials are distinguished by a good stability against oxidation and are also stable against wear due to sparks and arcs that occur during switching processes.

Suitable contact materials comprise in particular silver, gold and platinum. Suitable alloys as a contact material comprise in particular silver-nickel and silver-tin oxide.

The pipe lead is made from the second material. The second material is preferably selected from a steel, in particular a ferritic steel, or a steel alloy, in particular nickel-steel alloys and chromium steels.

The housing part is preferably made from a metal, materials described in relation to the pipe lead also being suitable in principle as material for the housing part. In addition, other steels, in particular austenitic steels, are also suitable. A material with a thermal expansion coefficient which is higher than that of the fixing material used is preferred.

Particularly in the case of the pipe lead, the second material may also be a composite material which is constructed from a plurality of layers. The selection of a composite material would, however, also be conceivable in principle for a separate flexible element or for the connection pin.

If a separate flexible material is used, the third material is preferably selected from a nonferrous metal or a nonferrous metal alloy. Examples of suitable materials comprise copper, copper alloys, in particular brass.

The pipe lead may be configured as a solid component or may be configured as a folded sheet-metal part. For example, the pipe lead is configured as a sheet-metal part, the thickness being increased in the sleeve portion in relation to the portion configured as a flexible element by single or multiple folding of the sheet-metal part.

Preferably, the sheet-metal part is a sheet-metal part coated on one side, the sheet-metal part being folded and arranged in such a way that a coated side of the sheet-metal part faces in the direction of a connection to the flexible element or to the connection terminal, and an uncoated side of the sheet-metal part faces in the direction of the fixing material.

The coating of the sheet-metal part may, in particular, be a nickel layer or another layer which facilitates connection, in particular by a soldering process. This is advantageous in particular when the sheet-metal part is made from a steel.

The coated sheet-metal part is preferably always folded and arranged in such a way that the coating does not come in contact with the fixing material. Accordingly, the coated side in the region of the sleeve portion preferably always lies on the inside and does not adjoin the fixing material. If the pipe lead is equipped with a flange, the coating in the region of this flange preferably faces in the direction of the joining partner. This achieves the effect that the pipe lead may be provided with a surface that promotes a weld and/or solder connection, even if it connects less well to the fixing material. By corresponding folding of the sheet-metal part, the surface most suitable for the connection to the respective joining partner always adjoins the latter.

A pipe lead configured as a solid component may also be partially coated in order to simplify the joining to the flexible element and/or to the connection terminal, particularly in a soldering process. In particular, a nickel layer may also be used in this case. The coating is preferably applied selectively only on the faces which lie opposite the joining partner. In particular, the faces facing the direction of the fixing material preferably remain free from the coating.

By means of the fixing material, the connection terminal arrangement is both mechanically held and electrically insulated from the housing part. The fixing material is preferably selected from a glass, a glass-ceramic or a ceramic.

A glass is particularly preferably used as the fixing material, the glass being selected from a borosilicate glass, a sodium-barium glass, an alkali glass, a silicate glass or a soda-lime glass. Borosilicate glasses and sodium-barium glasses are particularly suitable for matched glass-to-metal seals, and alkali glasses, silicate glasses and soda-lime glasses are particularly suitable for compression glass-to-metal seals.

An example of a material selection of the bushing is copper as the first material for the connection terminal and a ferritic steel as the second material for the pipe lead. A soda-lime glass, for example, may be used as the fixing material.

In this respect, with about 110 GPa, copper has a lower modulus of elasticity than the ferritic steel of the pipe lead with about 200 GPa. A resilient element formed from the copper material of the connection pin, for the same geometry of the resilient element, can therefore already resiliently deform under less applied force and thus absorb the shape change occurring because of thermal expansion of the connection pin, without transmitting detrimental forces onto the fixing material. While keeping the resilience of a pipe bushing made of ferritic steel, the dimensions of a resilient element manufactured from copper can accordingly be smaller, so that the bushing can be more compact.

The connection terminal arrangement may additionally comprise a further flexible element which is connected to the pipe lead, the flexible element and the further flexible element being connected on mutually opposite sides in relation to the through-opening to the connection terminal or, in an integral embodiment, merging into the latter.

The further flexible element is also preferably configured substantially in the form of a sleeve and preferably encloses the pin portion of the connection terminal at least partially. In relation to the through-opening in the housing part, one of the flexible elements may be oriented in the direction of the upper side and the respective other flexible element may be oriented in the direction of the lower side, so that the connection terminal can be held by both sides of the housing part.

The described bushings are, in particular, suitable for passing heavy currents in the range of several amperes, in particular more than 10 amperes and particularly preferably more than 100 amperes, securely through a hermetically sealed housing.

A further aspect of the invention is the provision of a housing which comprises at least one of the bushings described herein. The housing may, for example, be the housing of an electrical safety device, the housing of a control device such as a relay, or the housing of a battery module.

A further aspect of the invention proposes a relay which comprises a housing with at least two of the bushings described herein and a contacting device for establishing an electrical connection between the connection terminals of the two bushings.

The contacting device may in particular comprise an actuator that can be driven by means of an electrical signal so that a flow of current between the two connection terminals can be controlled as a function of such a control signal. One example of such an actuator is an electromechanical actuator with an electromagnet and a moving armature. In addition or as an alternative thereto, the contacting device may comprise a pyrotechnic actuator in which an explosive charge, which causes rapid disconnection of an electrical connection between the two connection terminals, can be ignited by means of an electrical signal. The housing may comprise further electrical bushings for feeding the electrical signals through.

The housing of the relay is preferably hermetically leaktight, so that on the one hand the interior of the housing is protected against environmental influences and on the other hand nothing can escape out of the interior of the housing. In this way, it is possible to fill the interior of the housing or at least a region around the contacting device with a so-called extinguishing gas. The purpose of such an extinguishing gas is to quench an arc, which may occur when disconnecting the electrical contact to the connection terminals, as rapidly as possible.

### BRIEF DESCRIPTION OF THE DRAWINGS

The invention will be described in more detail below with the aid of the figures, without restriction thereto.

FIG. 1: shows a first embodiment of the bushing in a schematic sectional view from the side,

FIG. 2: shows a second embodiment of the bushing in a schematic sectional view from the side,

FIG. 3: shows a third embodiment of the bushing in a schematic sectional view from the side,

FIG. 4: shows a fourth embodiment of the bushing in a schematic sectional view from the side,

FIG. 5: shows a fifth embodiment of the bushing in a schematic sectional view from the side,

FIG. 6: shows a sixth embodiment of the bushing in a schematic sectional view from the side,

FIG. 7: shows a seventh embodiment of the bushing in a schematic sectional view from the side, and

FIG. 8: shows an exemplary embodiment of a relay with two bushings according to the invention according to the sixth embodiment in a schematic sectional view from the side.

### DETAILED DESCRIPTION OF THE INVENTION

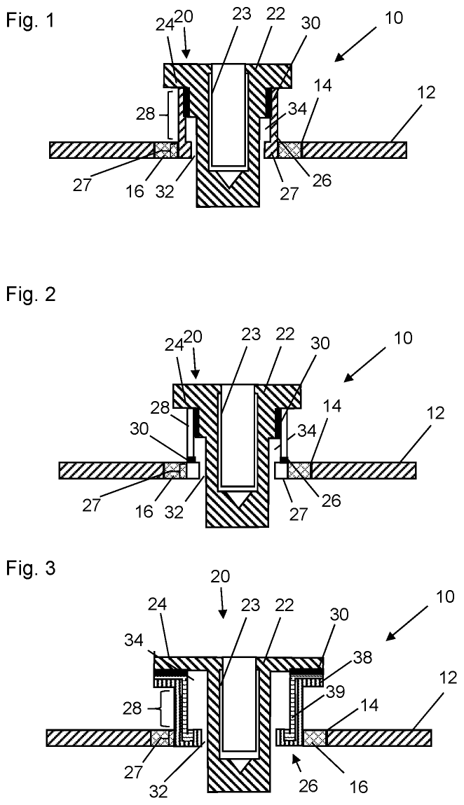

FIG. 1 shows a first embodiment of a bushing 10 with a connection terminal 22. The bushing 10 comprises a housing part 12 with a through-opening 14 therein. A connection terminal arrangement 20 is fed through this through-opening 14 and is held therein by a fixing material 16. The fixing material 16 hermetically seals the connection terminal arrangement 20 from the walls of the through-opening 14 so that the through-opening 14 is hermetically closed.

The connection terminal arrangement 20 comprises a connection terminal 22 and a pipe lead 26. In the exemplary embodiment shown, a longitudinal axis of the connection terminal 22 extends coaxially with a longitudinal axis of the pipe lead 26, the pipe lead 26 enclosing a part of the connection terminal 22. The fixing material 16 for sealing the connection terminal arrangement 20 is arranged between an outer wall of a sleeve portion 27 of the pipe lead 26 and an inner wall of the through-opening 14, there being a first gap 32 between an inner wall of the sleeve portion 27 and the connection terminal 22. As may be seen from the representation of FIG. 1, the sleeve portion 27 is therefore the portion of the pipe lead 26 that is arranged directly adjacent to the fixing material 16 inside the through-opening 14.

In the first embodiment of FIG. 1, the pipe lead 26 has a portion with a reduced thickness, which is used as a flexible element 28. In the portion with a reduced thickness, the outer diameter of the pipe lead 26 remains unchanged and only the inner diameter is reduced in order to reduce the thickness, so that the wall thickness of the pipe lead 26 and therefore its thickness are reduced in this portion. In this way, a second gap 34 between the flexible element 28 and a cylindrically configured pin portion of the connection terminal 22 becomes larger than the first gap 32. Furthermore, the flexibility of the pipe lead 26 is increased by the reduced thickness so that the flexible element 28 formed can become comparatively short in relation to known bushings with pipe leads but can nevertheless compensate by resilient deformation for a change in the dimensions of the connection terminal 22 initiated by temperature variations.

At an upper end, the connection terminal 22 has a collar 24, which in the exemplary embodiment of FIG. 1 is configured in the form of two steps, in each of which a diameter of the cylindrically configured connection terminal 22 respectively increases. The connection terminal 22 further has a threaded bore 23 on its upper side. The threaded bore 23 is in particular adapted to establish a connection to an electrical lead (not represented), the lead being screwed to the connection terminal 22. In other embodiments, other connecting means may of course also be provided instead of the threaded bore 23, or connecting means may be obviated so that the connection terminal 22 has for example a plane face on its upper side, which may for example be connected to an electrical lead by means of soldering or welding.

The flexible element 28 formed by the region with a reduced wall thickness of the pipe lead 26 is connected in the first embodiment represented in FIG. 1 to a side wall of the first step of the collar 24 of the connection terminal 22. Accordingly, the outer diameter of the first step of the collar 24 is less than the inner diameter of the fixing material 16. Furthermore, in the example represented the outer diameter of the second, larger step of the collar is less than the inner diameter of the through-opening 14. In further alternative embodiments, this diameter may however also be selected to be greater than the diameter of the through-opening 14. In the example represented, the connection takes place via a solder connection 30, although other connecting methods may of course also be used, for example welding. The connection between the flexible element 28 and the collar 24 is likewise configured to be hermetically leaktight so that the bushing 10 as a whole closes the through-opening 14 of the housing part 12 in a hermetically leaktight fashion.

The part of the flexible element 28 lying between the collar 24 and the sleeve portion 27 is adapted and configured to deform resiliently under an applied force, the first gap 32 and the second gap 34 providing the space required therefor. In this way, particularly without a detrimental action of force on the fixing material 16, it is possible to absorb force occurring because of a thermal expansion of the connection terminal 22 by means of a resilient shape change of the flexible element 28. Such a thermal expansion may, in particular, occur when the connection terminal 22 is loaded with heavy electric currents and is heated because of the electrical resistance that exists.

Advantageously, a wall thickness of the pipe lead 26 in the sleeve portion 27 is not reduced so that the pipe lead 26, the fixing material 16 and the housing part 12 can form a compression glass-to-metal seal in which a thermal expansion coefficient of the housing part 12 is selected to be higher than a thermal expansion coefficient of the fixing material 16. In this way, after glass-to-metal sealing of the fixing material 16, the housing part 12 contracts more than the fixing material 16 and thus exerts a pressure on the fixing material 16. The pipe lead 26 with the greater wall thickness in the region of the sleeve portion 27 can in this case form the required counterpressure, the flexible element 28 at the same time having the resilience required to absorb a thermal expansion of the connection terminal 22.

The connection terminal 22 of the first exemplary embodiment of FIG. 1 is made from a first material and the pipe lead 26 is made from a second material. This makes it possible to select the material properties optimally in each case for the two parts of the connection terminal arrangement 20. In particular, a material with a low electrical resistance may thus be selected for the connection terminal 22 and a rigid material with a high modulus of elasticity may be selected for the pipe lead 26, and in particular for its sleeve portion 27.

FIG. 2 represents a second exemplary embodiment of a bushing 10. In contrast to the first embodiment shown in FIG. 1, the pipe lead 26 is configured in two pieces so that the sleeve portion 27 and the flexible element 28 are composed of two parts and connected to one another via a connection 30, which is configured for example as a solder connection or weld connection. This allows that portion of the pipe lead 26 which is used as a flexible element 28 to be made from a third material and for only the sleeve portion 27 to be made from the second material. The third material is preferably selected in such a way that it has a lower modulus of elasticity than the second material and can therefore already exhibit a resilient deformation under less applied force.

FIG. 3 shows a third exemplary embodiment of a bushing 10. As already described with reference to FIG. 1, the bushing 10 has a housing part 12 with a through-opening 14, through which a connection terminal arrangement 20 with a connection terminal 22 and a pipe lead 26 is fed. The connection terminal arrangement is held by means of a fixing material 16 in the through-opening 14 and hermetically seals the latter.

In a similar way as in the first two embodiments of FIGS. 1 and 2, the connection terminal 22 has a collar 24 on one side, although in this case it is configured in one step and is arranged flush with one of the end sides of the connection terminal 22. A threaded bore 23, which allows screwing to an electrical lead, is again arranged in this end side.

In the third exemplary embodiment of FIG. 3, the pipe lead 26 is formed by a coated sheet-metal part which comprises a metal sheet 38 with a coating 39 applied on one side. The sheet-metal part is substantially tubular configured and encloses a cylindrical pin portion of the connection terminal 22, a longitudinal axis of the pipe lead 26 extending coaxially with a longitudinal axis of the connection terminal 22. The sheet-metal part forms a sleeve region 27 with an increased thickness at a first end and forms a flange at a second end. The sheet-metal part is configured in such a way that the coating 39 faces inward in the direction of the cylindrical pin portion of the connection terminal 22 and the uncoated side of the sheet-metal part accordingly faces outward. The sleeve region 27 is obtained by single or multiple folding of the sheet-metal part. The sheet-metal part is in this case deformed in such a way that the coating 39 of the metal sheet 38 is folded onto itself and therefore lies on the inside. Accordingly, the uncoated side of the metal sheet 38 in the sleeve region 27 faces in the direction of the fixing material 16. The flange is likewise obtained by deforming the sheet-metal part, the coating 39 of the metal sheet 38 in this case facing in the direction of the collar 24 of the connection terminal 22 and being connected thereto via a connection 30, which is configured for example as a solder connection. In order to provide an area which is as large as possible for the connection 30 to the flange, an outer diameter of the collar is as represented preferably selected to be greater than an inner diameter of the fixing material 16. In the exemplary embodiment represented in FIG. 3, the diameter of the collar 24 is selected to be less than the inner diameter of the through-opening 14. For a further increase of the connecting area, the outer diameter of the collar 24 may however also be selected to be greater than the inner diameter of the through-opening 14.

Between the flange and the sleeve region 27, the sheet-metal part is not folded and forms a portion there which has a smaller thickness than the sleeve region 27 and is used as a flexible element 28. A first gap 32 between the sleeve region 27 and the cylindrical pin portion of the connection terminal 22 is therefore smaller than a second gap 34 between the flexible element 28 and the cylindrical pin portion of the connection terminal 22.

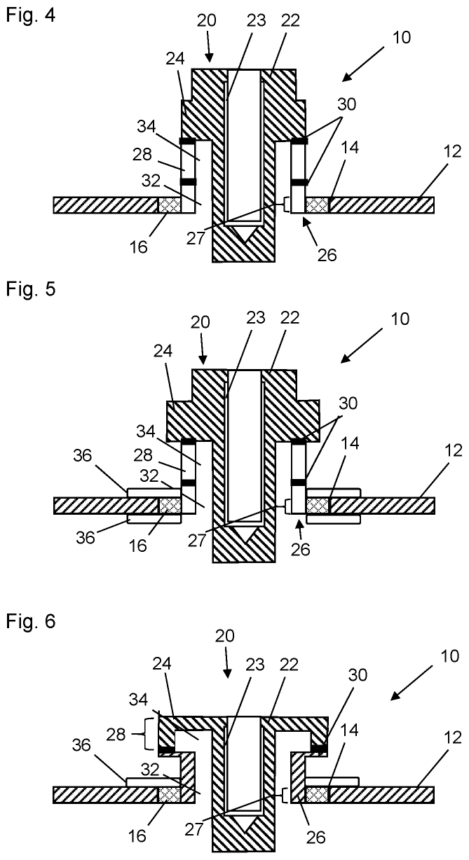

FIG. 4 shows a fourth exemplary embodiment of a bushing 10. The bushing 10 again has a housing part 12 with a through-opening 14, through which a connection terminal arrangement 20 with a connection terminal 22 and a pipe lead 26 is fed. The connection terminal arrangement is held by means of a fixing material 16 in the through-opening 14 and hermetically seals the latter.

In a similar way as in the first two embodiments of FIGS. 1 and 2, the connection terminal 22 has a collar 24 on one side, which in this case is likewise configured in multiple steps, the collar 24 having a first step and a second step starting from a lower side, which lies opposite the upper side with a threaded bore 23, a diameter of the first step being greater than a diameter of the second step. In other embodiments, however, it would of course also be possible to configure the collar 24 differently, for example with only one step which is arranged flush with the upper side of the connection terminal 22.

On a lower side of the collar 24, the pipe lead 26 is connected to the collar 24 via a connection 30 which, for example, is configured as a solder connection. The pipe lead 26 is in this case configured in two pieces, a sleeve portion 27 lying opposite the fixing material 16 being made from the second material and a part used as a flexible element 28 being made from a third material, which has a lower modulus of elasticity than the second material. The two parts of the pipe lead 26 in the example shown are likewise connected via a connection 30, which is configured for example as a solder connection. The pipe lead 26 is arranged in such a way that the flexible element 28 faces toward the collar 24. The pipe lead 26 is substantially cylindrically configured overall and encloses a cylindrical pin portion of the connection terminal 22 in such a way that the longitudinal axis of the pipe lead 26 extends coaxially with a longitudinal axis of the connection terminal 22. The dimensions of the collar 24 and of the pipe lead 26 are in this case selected in such a way that the outer diameter of the pipe lead 26 corresponds to the larger diameter of the collar 24 and the two parts therefore merge into one another without a step.

FIG. 5 shows a fifth exemplary embodiment of a bushing 10, which resembles the fourth exemplary embodiment of FIG. 4. Unlike the fourth exemplary embodiment, the diameter of the pipe lead 26 is less than the diameter of the collar 24. Furthermore, in order to improve a dielectric strength of the bushing 10, an additional insulation material 36 is provided, which is configured in this case as two insulation disks. A first insulation disk covers an upper side of the fixing material 16 and an adjacent part of the upper side of the housing part 12. A second insulation disk covers a lower side of the fixing material 16 and an adjacent part of the lower side of the housing part 12. By the insulation material 36 arranged in this way, in particular a leakage path between the connection terminal arrangement 20 and the housing part 12 is increased so that the dielectric strength of the bushing 10 is improved. Instead of insulation disks, the insulation material 36 could for example also be applied as an insulating coating. Furthermore, depending on the application, it may be also sufficient to arrange the insulation material 36 only on one side of the bushing 10, for example the upper side.

FIG. 6 shows a sixth exemplary embodiment of a bushing 10. The bushing 10 again has a housing part 12 with a through-opening 14, through which a connection terminal arrangement 20 with a connection terminal 22 and a pipe lead 26 is fed. The connection terminal arrangement 20 is held by means of a fixing material 16 in the through-opening 14 and hermetically seals the latter.

The connection terminal 22 in this case has a collar 24 flush with an upper side with a threaded bore 23, a sleeve-shaped portion of the connection terminal 22, which is used as a flexible element 28, following on from a lower side of the collar 24 that faces toward the through-opening 14. The outer diameter of the portion configured in the form of a sleeve corresponds in this example to the outer diameter of the collar 24, although the outer diameter may conversely also be selected to be smaller. Further, in the exemplary embodiment represented in FIG. 6, the outer diameter of the collar 24 is selected to be greater than the inner diameter of the fixing material 16 and less than the inner diameter of the through-opening 14. The outer diameter of the collar 24 could, however, alternatively also be selected to be greater than the inner diameter of the through-opening 14.

The sleeve-shaped portion is used as a flexible element 28 and is connected to a pipe lead 26 via a connection 30, which is configured for example as a solder connection. The pipe lead 26 comprises a sleeve portion 27, which adjoins the fixing material 16. There is a first gap 32 between the sleeve portion 27, which encloses a cylindrical pin portion of the connection terminal 22, and the connection terminal 22. In the embodiment represented in FIG. 6, the sleeve portion 27 is extended upward and widens at an end facing toward the collar 24 to form a connecting flange. At the connecting flange, the pipe lead 26 is connected to the flexible element 28 of the connection terminal 22. The pipe lead 26 is made from a second material which has a higher modulus of elasticity than a first material from which the connection terminal 22 is made. Accordingly, forces that occur in the event of a thermal expansion of the connection terminal 22 are absorbed by means of a resilient shape change of the flexible element 28 of the connection terminal 22. Advantageously, no force resulting from the thermal expansion is therefore transmitted via the pipe sleeve 26, and in particular its sleeve portion 27, onto the fixing material 16, or such transmission is reduced at least to an insignificant level.

The sleeve-shaped portion of the connection terminal 22, which is used as a flexible element 28, surrounds the cylindrical pin portion of the connection terminal 22, a longitudinal axis of the sleeve-shaped portion being arranged concentrically with a longitudinal axis of the cylindrical pin portion and there being a second gap 34 between an inner side of the sleeve-shaped portion, or the flexible element 28 formed by the latter, and the cylindrical pin portion.

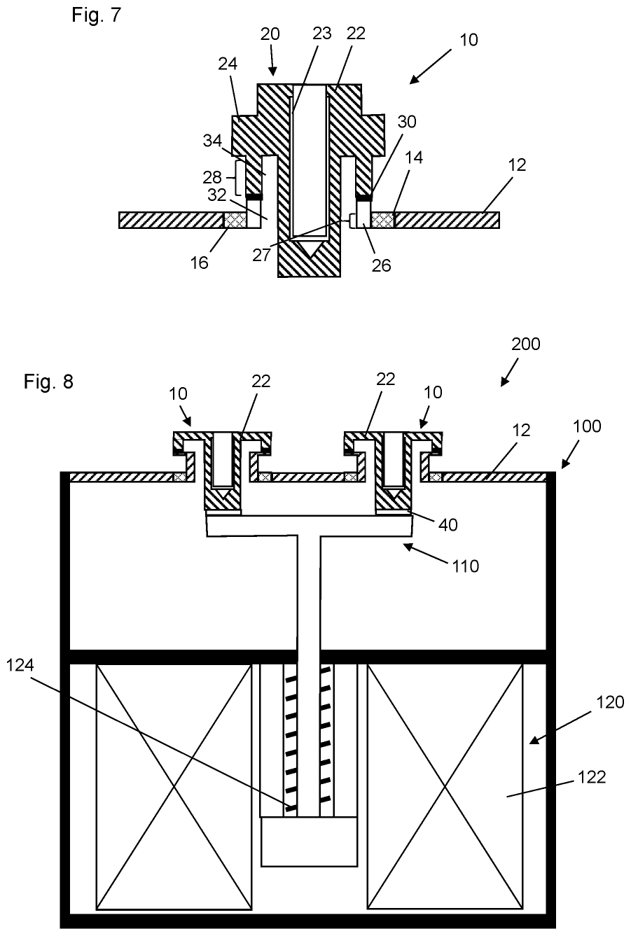

FIG. 7 shows a seventh exemplary embodiment of a bushing 10, in which, in a similar way as in the sixth exemplary embodiment of FIG. 6, a sleeve-shaped portion of the connection terminal 22 is configured as a flexible element 28.

In contrast to the embodiment of FIG. 6, the portion of the connection terminal 22 that is used as a flexible element 28 in this case has a smaller outer diameter than the collar 24 and the collar 24 is configured in multiple steps, in a similar way as in the exemplary embodiments of FIGS. 4 and 5. Furthermore, in this case the pipe lead 26 does not have a region with an increased diameter that is used as a connecting flange. In the example represented, the outer and inner diameters of the pipe lead 26 and of the flexible element 28 are configured to be equal. Since the first material of the connection terminal 22, and therefore of the flexible element 28 configured integrally therewith, has a lower modulus of elasticity than the second material of the pipe lead 26, forces that occur because of thermal expansion of the connection terminal 22 are absorbed by means of a resilient deformation of the flexible element 28 and the shape of the pipe lead 26 remains substantially unchanged.

FIG. 8 represents an example of a relay 200, which is configured for example as a high-power relay for an electric vehicle. The relay 200 comprises a housing 100 with a housing part 12 configured as a cover. The housing part 12 comprises two electrical bushings 10 with connection terminals 22, to which a circuit to be switched by the relay 200 can be attached. For example, electrical connectors may for this purpose be screwed to the connection terminals 22. In the example represented in FIG. 8, the bushings 10 are configured as described in reference to FIG. 6. Other bushings 10 as described herein may of course also be used.

Arranged inside the housing 10, there is a contacting device 110 which is adapted to electrically connect the two connection terminals 22 in a first position, so that a flow of current is possible, and to electrically disconnect the two connection terminals 22 in a second position, so that no flow of current is possible. As shown in the representation of FIG. 8, the connection terminals 22 may have a contact coating 40, which consists of a contact material, on their end side that faces toward the contacting device 110. The contact material, for example silver or a silver-copper or silver-nickel alloy, is stable against oxidation and reduces an electrical contact resistance between the respective connection terminal 22 and the contacting device 110.

In order to move the contacting device from one position to the other, an actuator 120 which is configured as an electromagnetic actuator is provided in the exemplary embodiment represented in FIG. 8. For electrical contacting of the actuator 120, the housing 100 has further electrical bushings (which are not visible in the sectional representation of FIG. 6).

By means of an electromagnet 122 of the actuator 120, the contacting device 110 may then for example be brought into the first position by energizing the electromagnet 122, so that an electric current can flow between the two connection terminals 22. If the energizing of the electromagnet 122 is ended, the contacting device 110 may for example be brought into the second position by means of a spring 124, so that a flow of current is no longer possible between the two connection terminals 22. For rapid extinguishing of an arc that may possibly occur when the contacting device 110 is disconnected from the connection terminals 22, the interior of the housing 100 may be filled with a so-called extinguishing gas. Since the bushings 10 according to the invention are hermetically leaktight, the extinguishing gas cannot escape from the housing 100.

In addition to the actuator 120, a further actuation device for moving the contacting device 110 may be provided in the relay 200. For example, a pyrotechnic device may be provided (not represented in FIG. 8), which, when an igniter is energized, triggers an explosive charge that then moves the contacting device 110 rapidly into the second position in which the connection terminals 22 are electrically disconnected from one another.

The claims are not restricted to the exemplary embodiments described herein. In particular, many variants in which individual features of the exemplary embodiments described herein are combined with one another are possible.

### LIST OF REFERENCE SIGNS

10 bushing
12 housing part
14 through-opening
16 fixing material
20 connection terminal arrangement
22 connection terminal
23 threaded bore
24 collar
26 pipe lead
27 sleeve portion
28 flexible element
30 solder connection
32 first gap
34 second gap
36 insulation material
38 metal sheet
39 coating
40 contact coating
100 housing
110 contacting device
120 actuator
122 electromagnet
124 spring
200 relay

What is claimed:

1. A bushing with a connection terminal for a high-power relay, comprising
a housing part with a through-opening and a connection terminal arrangement, which is fed through the through-opening and is sealed from the through-opening by a fixing material,
wherein the connection terminal arrangement comprises a connection terminal made of a first material and a pipe lead made of a second material, the pipe lead enclosing at least a part of the connection terminal and the fixing material being arranged between an outer wall of a sleeve portion of the pipe lead and an inner wall of the through-opening in order to seal the connection terminal arrangement, there being a first gap between an inner wall of the sleeve portion and the connection terminal,
wherein the connection terminal arrangement further comprises a flexible element via which the pipe lead is connected to the connection terminal, the flexible element enclosing a pin portion of the connection terminal and there being a second gap between the pin portion of the connection terminal and the flexible element,
wherein
i) the flexible element is formed integrally with the pipe lead as a portion of the pipe lead having a reduced thickness,
ii) the flexible element is made from a third material, or
iii) the flexible element is formed integrally with the connection terminal.

2. The bushing of claim 1, wherein the connection terminal has a collar and the flexible element according to variant i) or ii) is connected to the latter on a side of the collar facing toward the through-opening, or in that in the case of an integral embodiment with the pipe lead according to variant iii) the portion of the connection terminal forming the flexible element starts on the side of the collar facing toward the through-opening.

3. The bushing of claim 1, wherein the connection terminal has a collar and the flexible element according to variant i) or ii) is connected to the latter on a lateral face of the collar.

4. The bushing of claim 2, wherein the collar is arranged outside the through-opening.

5. The bushing of claim 1, wherein the pipe lead has a continuous or abrupt increase in diameter outside the through-opening on a side facing toward the flexible element, and the pipe lead is connected to the flexible element in this region with an increased diameter.

6. The bushing of claim 1, wherein the connection terminal has a threaded bore on an outwardly facing side in order to fasten a connection line.

7. The bushing of claim 1, wherein the fixing material and an adjacent portion of the housing part are covered with an insulation material on an upper side and/or on a lower side of the bushing.

8. The bushing of claim 7, wherein the insulation material is configured as a disk of electrically insulating material or as a coating of an electrically insulating material.

9. The bushing of claim 1, wherein the bushing is configured as a compression glass-to-metal seal in which a thermal expansion coefficient of the housing part is higher than a thermal expansion coefficient of the fixing material.

10. The bushing of claim 1, wherein the first material has a lower electrical resistance than the second material and/or in that the first material has a lower modulus of elasticity than the second material.

11. The bushing of claim 1, wherein the third material according to variant ii) has a lower modulus of elasticity than the second material and preferably a lower modulus of elasticity than the first material.

12. The bushing of claim 1, wherein the first material is a nonferrous metal.

13. The bushing of claim 12, wherein the nonferrous metal is selected from the group consisting of brass, copper, copper alloys, aluminum and aluminum alloys.

14. The bushing of claim 1, wherein an end side of the connection terminal is coated with a contact material in order to reduce the contact resistance and/or to reduce sparking.

15. The bushing of claim 1, wherein the pipe lead is configured as a sheet-metal part, the thickness being increased in the sleeve portion by single or multiple folding of the sheet-metal part in relation to the portion configured as a flexible element.

16. The bushing of claim 15, wherein the sheet-metal part is a sheet-metal part coated on one side and the sheet-metal part is folded and arranged so that a coated side of the sheet-metal part faces in the direction of a connection to the flexible element or to the connection terminal, and an uncoated side of the sheet-metal part faces in the direction of the fixing material.

17. The bushing of claim 1, wherein the second material is a steel or a steel alloy.

18. The bushing of claim 17, wherein the steel is a ferritic steel, or the steel alloy is a nickel steel alloy or a chromium steel alloy.

19. The bushing of claim 1, wherein the fixing material is selected from a glass, a glass-ceramic or a ceramic.

20. The bushing of claim 19, wherein the glass is selected from a borosilicate glass, a sodium-barium glass, an alkali glass, a silicate glass or a soda-lime glass.

21. The bushing of claim 1, wherein the connection terminal arrangement comprises a further flexible element which is connected to the pipe lead, the flexible element and the further flexible element being connected on mutually opposite sides in relation to the through-opening to the connection terminal or, in an integral embodiment, merging into the latter.

22. A housing comprising a bushing of claim 1.

23. A relay comprising at least two bushings of claim 1 and a contacting device for establishing an electrical connection between the connection terminals of the two bushings.
